(19) United States
(12) Patent Application Publication
(10) Pub. No.: US 2005/0102285 A1
(43) Pub. Date: May 12, 2005

(54) Image recognition

(76) Inventor: James Leonard Austin, Fimber (GB)

Correspondence Address: BARNES & THORNBURG, P.O. BOX 2786, CHICAGO, IL, 60690-2786, US

(21) Appl. No.: 10/498,077

(22) PCT Filed: Dec. 10, 2002
(86) PCT No.: PCT/GB02/05592

(30) Foreign Application Priority Data
Dec. 10, 2001 (GB) 0129482.6

(51) Int. Cl. G06F 7/00

(52) U.S. Cl. 707/5

(57) ABSTRACT

In a data processing system for recognising a subject image (1), first processing means (2) is arranged to derive from the subject image (1) at least one graph having a plurality of points representing topographical data of the subject image (1). Second processing means (3) is arranged to create, for each of those points, attribute data representing at least one attribute of the subject image (1) corresponding to the respective point, which attribute is in addition to the topographical data. At least one correlation matrix memory (7) is arranged to provide at least part of storage means (4) arranged to store data of stored images; comparison means (5) arranged to compare the data of the subject image (1) with the stored data of the stored images; and identifying means (6) arranged to identify matches between data of the subject image (1) and the stored data. The data processing system may be used with advantage in recognising natural images e.g. human faces.

This invention relates to the recognition of images, and is concerned, particularly although exclusively, with the recognition of natural images.

By “natural image” is meant an image of an object that occurs naturally—for example, an optical image such as a photograph, as well as images of other wavelengths—such as x-ray and infra-red, by way of example. The natural image may be recorded and/or subsequently processed by digital means, but is in contrast to an image—or image data—that is generated or synthesised by computer or other artificial means.

The recognition of natural images can be desirable for many reasons. For example, distinctive landscapes and buildings can be recognised, to assist in the identification of geographical locations. The recognition of human faces can be useful for identification and security purposes. The recognition of valuable animals such as racehorses may be very useful for identification purposes.

Various attempts have been made to provide systems and methods to recognise faces, for example. Generally, this involves comparing a current optical image with a number of stored optical images, and looking for a match. Although theoretically possible, this gives rise to a number of practical problems. For example, the current optical image may have numerous small differences from the stored optical image with which it should match—this is a factor that does not usually arise with synthetic images. Large amounts of computer processing however are required and, even with relatively powerful modern computing systems, the matching process tends to take an unacceptably long time and produce unacceptably low recognition success.

Certain preferred embodiments of the present invention aim to provide systems and methods for matching a natural image with a respective one of a large number of stored images.

Other preferred embodiments of the present invention aim to provide systems and methods for matching both natural and synthetic images with a respective one of a large number of stored images.

According to one aspect of the present invention, there is provided a data processing system for recognising a subject image, the system comprising:
a. first processing means arranged to derive from the subject image at least one graph having a plurality of points representing topographical data of the subject image;
b. second processing means arranged to create, for each of said points, attribute data representing at least one attribute of the subject image corresponding to the respective point, which attribute is in addition to said topographical data; and
c. at least one correlation matrix memory that is arranged to provide at least part of:
d. storage means arranged to store data of stored images;
e. comparison means arranged to compare the data of the subject image with the stored data of the stored images; and
f. identifying means arranged to identify matches between data of the subject image and said stored data.

Preferably, said identifying means is arranged to calculate, for each of a plurality of points of the subject image, and for the or each said item of attribute data pertaining to that point, potential matches from said stored data for said item of attribute data, and support from other such points for each of said potential matches, and then to progressively remove potential matches of least support.

Preferably, said attribute data comprises data representing at least one of colour, texture and curvature at the respective said point.

Preferably, for each said point, said attribute data is relational data, representing a difference in corresponding values of a common attribute as between the respective point and another one of said points.

Preferably, said subject image is a natural image.

Preferably, said natural image is an image of a human face.

In another aspect, the invention provides a method of recognising a subject image, comprising the steps of:
a. deriving from the subject image at least one graph having a plurality of points representing topographical data of the subject image;
b. creating for each of said points attribute data representing at least one attribute of the subject image corresponding to the respective point, which attribute is in addition to said topographical data; and
c. at least partly by means of a correlation matrix memory:
d. storing data of stored images;
e. comparing the data of the subject image with the stored data of the stored images; and
f. identifying matches between data of the subject image and said stored data.

Such a method may be carried out by a system according to any of the preceding aspects of the invention.

In another aspect, the invention provides a data processing system for recognising a natural image, the system comprising:
a. processing means arranged to derive from the natural image at least one graph having a plurality of points representing data of the natural image; and
b. at least one correlation matrix memory that is arranged to provide at least part of:
c. storage means arranged to store data of stored images;
d. comparison means arranged to compare the data of the natural image with the stored data of the stored images; and
e. identifying means arranged to identify matches between data of the natural image and said stored data.

Preferably, said identifying means is arranged to calculate, for each of a plurality of points of the natural image, potential matches from said stored data for an item of data at that point, and support from other such points for each of said potential matches, and then to progressively remove potential matches of least support.

Preferably, for each said point, said data is relational data, representing a difference in corresponding values of a common property as between the respective point and another one of said points.

Preferably, said data is positional data.

In another aspect, the invention provides a method of recognising a natural image, comprising the steps of:
a. deriving from the natural image at least one graph having a plurality of points representing data of the natural image; and
b. at least partly by means of a correlation matrix memory:
c. storing data of stored images;
d. comparing the data of the natural image with the stored data of the stored images; and
e. identifying matches between data of the natural image and said stored data.

Such a method may be carried out by a system according to any of the preceding aspects of the invention.

For a better understanding of the invention, and to show how embodiments of the same may be carried into effect, reference will now be made, by way of example, to the accompanying diagrammatic drawings, in which:

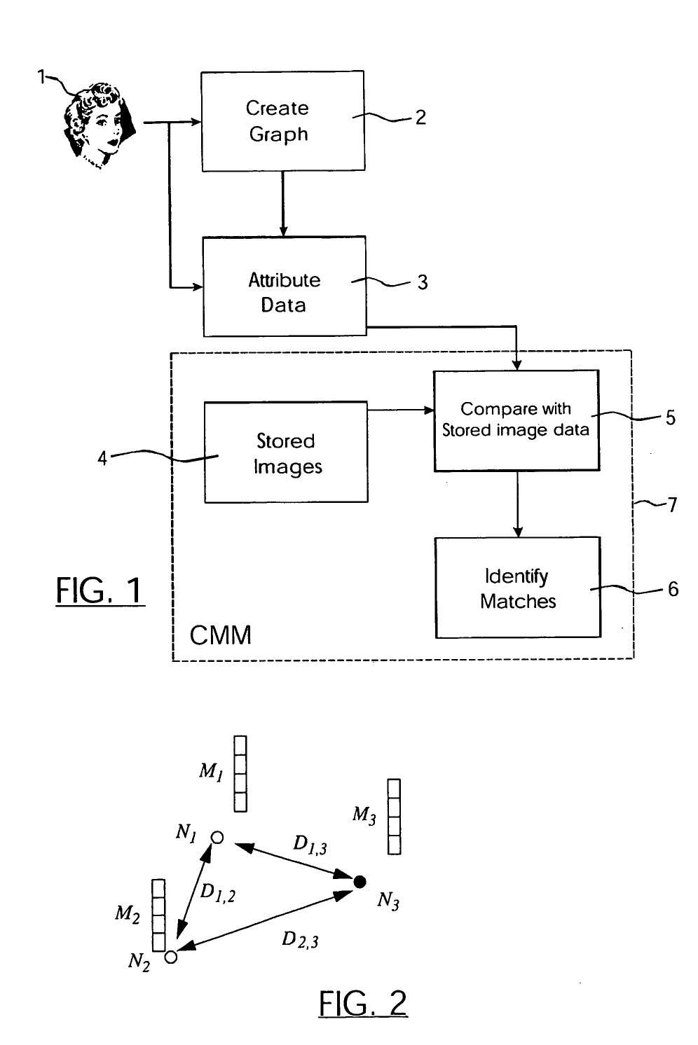

FIG. 1 illustrates one example of a system for recognising natural images of human faces, in accordance with one embodiment of the invention;

FIG. 2 illustrates a number of graphical points and relational data between those points;

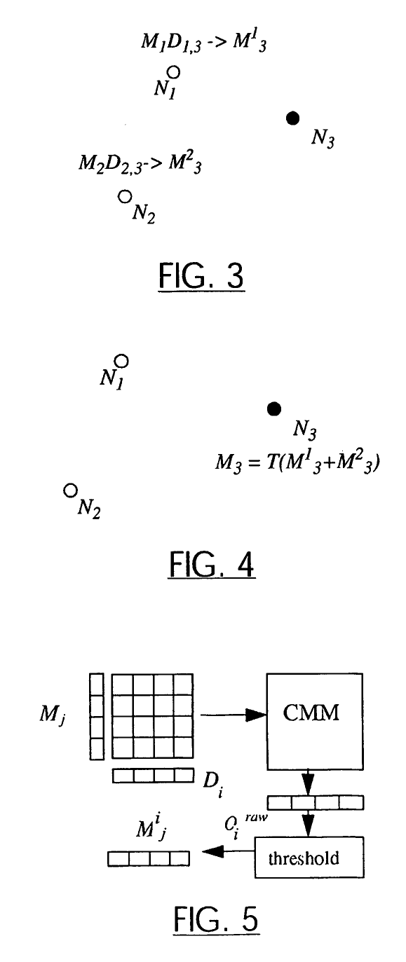

FIG. 3 illustrates computation of model support between points;

FIG. 4 illustrates calculation of model support at a point; and

FIG. 5 illustrates implementation by way of a correlation matrix memory.

In FIG. 1, a subject image that is a natural image, that is to say, in this example, an optical image of a human head, is reduced to digital data and input to a first processing means 2 which derives from the image data at least one graph having a plurality of points representing topographical data of the original image. Methods of doing this are well known to those skilled in the art—for example, by use of stereo algorithms, structured light, and so on. In many examples, a plurality of graphs may be derived, but for ease of explanation, it will be assumed in the following that there is just one graph. The graph has a plurality of points representing relationships between two variables—for example, x and y coordinates—and values of points on the graph may be conveniently stored as a table.

The image data is also input to a second processing means 3 which creates, for each of the points of the graph, attribute data representing at least one attribute of the natural image corresponding to the respective point, which attribute is in addition to the topographical data. For example, such attributes may be one or more of colour, texture and curvature.

A storage means 4 stores topographical and attribute data for a plurality of known, stored images.

A comparison means 5 compares the data of the original image 1 with the stored data of the stored images.

An identifying means 6 identifies matches between data of the original image and that of the stored images.

The storage means 4, comparison means 5 and identifying means 6 are all at least partly provided by a correlation matrix memory (CMM) 7.

For a description of a CMM and how it may be used to match incomplete data with stored data, the reader is referred to our prior patent publication WO 01/01345. Many of the techniques that are employed in that publication may be utilised in embodiments of the present invention.

In order to compare the data of the original image with that of the stored images, a technique called Relaxation By Elimination (RBE) is utilised, and this will be described with reference to FIGS. 2 to 5.

We assume for this explanation that the natural image to be recognised has i data points Ni, and that the stored images form a set of j models Mj with which data at points Ni is to be compared. For simplicity, in this example, the models Mj each have the same number i of data points, and for ease of reference, the data points of the models Mj will be called “model points”. However, more generally, the models Mj may have differing numbers of model points.

FIG. 2 illustrates a simple example where i=3, giving three data points N1 to N3 of the image to be identified, and their inter-point distances, D_{1,3} etc.

For each data point Ni, there is created a list Mj of models having data for corresponding properties or attributes at model points, which matches the data at data point Ni. Such property or attribute could be position, inter-point distance, colour, texture, curvature, etc. Distances from each node Ni to, say, a centre of mass, could alternatively or additionally be utilised.

Thus, each data point Ni is “seeded” with a respective list of models Mj that could conceivably fit the initial item of data at the data point Ni. Models having data at model points that could not possibly match the corresponding item of data at the corresponding data point Ni are discarded—which greatly assists processing speed.

The system then applies knowledge of inter-point distances. It visits each data point Ni, and for each checks the knowledge held at other data points to find any support for the models at Ni. That is, if a model Mj supports the inter-point distance D_{1,3} at data point N1, then we ask: is the same model listed at data point N3 to support the same distance D_{1,3}? If so, that model at data point N1 is supported at data point N3.

The computation of model support to node N3 by nodes N1 and N2 is visualised in FIG. 3, and expressed below.

```
For each data point, i, in N.
    For all j, visit each data point, j, in N (not including i)
        Calculate the distance, D_{i,j,} between the two points, i and j.
        Find which of the current models, M′ⱼ, support
        points at the distance
        D_{i,j}.
    endfor
endfor
```

This results in a support vector, Mⱼᵢ that shows how the data point supports the data point i, given the models at j and the distance Di,j. This is where use of the CMM is particularly advantageous. The system then looks at each data point Ni and computes the support for its models that is given from other nodes.

The computation of model support to node N3 by other nodes is visualised in FIG. 4, and expressed below.

```
For each point, i, in N.
    Sum the support for all model points, Mᵢ to get
    the raw support Mᵢ^{raw} at the node i.
    Threshold Mᵢ^{raw} at a level T to
    get a binary model support vector, Mi.
endfor
```

The system then eliminates all models that have little support. In this case, it is performed over all data points Ni and all models Mj at each data point. In effect, this is by setting T to an appropriate value.

Over all points p in NxM
Find the model with the least support, and delete it.
endfor

The above processes are reiterated until all models have a support that exceeds the threshold T. This may leave one or a plurality of models with the same support. False matches can then be eliminated by using conventional geometric matching (or other techniques) on what is, now, a small set of candidate models.

The process halts when the support at all nodes fails to change. In practice, this may not be the lowest energy state of the system, in that a large number of nodes may remain With high support. In this case a ‘kick start’ can be given to the node with the highest entropy, by increasing T at that node, effectively removing the least supported model at that node.

In practice, all neighbours of a given node are selected to provide information to update that node. It is possible to use a subset of the neighbours, but this leads to slower convergence.

The approach uses a process of removing points that do not get support from other nodes. The motivation for this is based on the observation that it is simpler and more reliable to eliminate all models that have no support, and to let this knowledge propagate, than to select models that have the highest support as found in other relaxation based methods.

The CMM 7 is used to store information concerning “which points support which models”.

At each data point Ni there is a list of models Mj that have model points that match the current data point. A search must be made of the model base to find models that are supported. The input of the CMM is a 2D matrix shown in FIG. 5, which codes currently supported models, Mj, against, say, the inter-point distance of interest, Dj,i. This is input to the CMM, which then looks up to find the models that match and outputs a raw vector Oᵢ^{raw} that expresses this. This vector is then thresholded at a level Y to obtain a binary vector giving the models supported at data point j from data point i, given as M^{j}ᵢ. This information is sent to the data point currently being evaluated where it is combined as given above. The threshold level, Y, is determined from the number of bits set in the input to the CMM, which is controlled by the number of currently matching models. In practice Y can be reduced. The parameterisation of the memory is derived from analysis of CMM storage ability.

The above description is based, for the sake of simplicity, on a single data value at each data point Ni—for example, inter-point distance Di,j. However, to provide more effective matching or recognition for natural images, further attribute data is also considered. For example, at each data point Ni, such attribute data values as colour, texture and curvature may be considered. Preferably, such attribute data values are expressed in relational terms—that is, for example, “data point N3 is redder than data point N1”—or “has smoother textured than”—or “has lower curvature than”. These relational attribute data values can conveniently be superposed upon or otherwise combined with the inter-point distance values Di,j, to provide very distinctive links between data points Ni, and thereby speed matching and recognition.

Thus, for example, in FIG. 5, the 1-dimensional array Dn may be replaced by a multi-dimensional matrix, containing a plurality of relational attribute data values, in addition to the inter-point data.

If there are two (or more) one-dimensional arrays such as Dn for respective attributes D1 and D2, a matrix can be created from their outer product, to replace the illustrated single array Dn—or one can adopt simple superposition of data (logical OR-ing of the two arrays).

It will be appreciated that the CMM provides a particularly convenient way to superpose data values and, in this respect, the reader is referred to our prior patent publication WO 01/01345, where various aspects and methods for the superposition of data items for both memory training and memory recall are disclosed. The above-mentioned patent publication also describes how various possible matches to query data can be reduced, and subsequent matching done by other techniques, on a small number of candidate matches.

Although in the illustrated example, the data points Ni are labelled, it may be possible to dispense with such labelling, thereby reducing the amount of data to be processed and correspondingly increasing the speed of processing, without, rather surprisingly, losing a great deal in accuracy.

Whilst, in the above example, a single CMM is shown and described, in practice an array of CMM's may be utilised—as disclosed in our above-mentioned patent publication, for example, which also discloses various techniques for compressing the size of CMMs.

Preferred embodiments of the invention may be utilised for recognising natural images—for example, human faces—from a large collection of stored images, in a reasonably speedy manner.

Other embodiments of the invention may be adapted to recognise synthesised images in a similar manner.

For the recognition of natural images, positional data only, or another single property or attribute, may be utilised for matching the natural image with stored images.

In this specification, the verb “comprise” has its normal dictionary meaning, to denote non-exclusive inclusion. That is, use of the word “comprise” (or any of its derivatives) to include one feature or more, does not exclude the possibility of also including further features.

The reader's attention is directed to all and any priority documents identified in connection with this application and to all and any papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A data processing system for recognising a subject image, the system comprising:
a. a first processing means arranged to derive from the subject image at least on graph having a plurality of points representing topographical data of the subject image;
b. second processing means arranged to create, for each of said points, attribute data representing at least one attribute of the subject image corresponding to the respective point, which attribute is in addition to said topographical data; and
c. at least one correlation matrix memory that is arranged to provide at least part of:
d. storage means arranged to store data of stored images;
e. comparison means arranged to compare the data of the subject image with the stored data of the stored images; and
f. identifying means arranged to identify matches between data of the subject image and said stored data.

2. A system according to claim 1, wherein said identifying means is arranged to calculate, for each of a plurality of points of the subject image, and for the or each said item of attribute data pertaining to that point, potential matches from said stored data for said item of attribute data, and support from other such points for each of said potential matches, and then to progressively remove potential matches of least support.

3. A system according to claim 1, wherein said attribute data comprises data representing at least one of colour, texture and curvature at the respective said point.

4. A system according to claim 1, wherein, for each said point, said attribute data is relational data, representing a difference in corresponding values of a common attribute as between the respective point and another one of said points.

5. A system according to claim 1, wherein said subject image is a natural image.

6. A system according to claim 5, wherein said natural image is an image of a human face.

7. A method of recognising a subject image, comprising the steps of:
a. deriving from the subject image at least one graph having a plurality of points representing topographical data of the subject image;
b. creating for each of said points attribute data representing at least one attribute of the subject image corresponding to the respective point, which attribute is in addition to said topographical data; and
c. at least partly by means of a correlation matrix of memory:
d. storing data of stored images;
e. comparing the data of the subject image with the stored data of the stored images; and
f. identifying matches between data of the subject image and said stored data.

8. A method according to claim 7, when carried out by a system according to a data processing system for recognising a subject image, the system comprising:
a. a first processing means arranged to derive from the subject image at least on graph having a plurality of points representing topographical data of the subject image;
b. second processing means arranged to create, for each of said points, attribute data representing at least one attribute of the subject image corresponding to the respective point, which attribute is in addition to said topographical data; and
c. at least one correlation matrix memory that is arranged to provide at least part of:
d. storage means arranged to store data of stored images;
e. comparison means arranged to compare the data of the subject image with the stored data of the stored images; and
f. identifying means arranged to identify matches between data of the subject image and said stored data.

9. A data processing system for recognising a natural image, the system comprising:
a. processing means arranged to derive from the natural image at least one graph having a plurality of points representing data of the natural image; and
b. at least one correlation matrix that is arranged to provide at least part of:
c. storage means arranged to store data of stored images;
d. comparison means arranged to compare the data of the natural image with the stored data of the stored images; and
e. identifying means arranged to identify matches between data of the natural image and said stored data.

10. A system according to claim 9, wherein said identifying means is arranged to calculate, for each of a plurality of points of the natural image, potential matches from said stored data for an item of data at that point, and support from each other such points for each of said potential matches, and then to progressively remove potential matches of least support.

11. A system according to claim 9, wherein, for each said point, said data is relational data, representing a difference in corresponding values of a common property as between the respective point and another one of said points.

12. A system according to claim 9, wherein said data is positional data.

13. A method of recognising a natural image, comprising the steps of:
a. deriving from the natural image at least one graph having a plurality of points representing data of the natural image; and
b. at least partly by means of a correlation matrix memory:
c. storing data of stored images;
d. comparing the data of the natural image with the stored data of the stored images; and
e. identifying matches between data of the natural image and said stored data.

14. A method according to claim 13, when carried out by a data processing system for recognising a natural image the system comprising the steps of:
a. processing means arranged to derive from the natural image at least one graph having a plurality of points representing data of the natural image; and
b. at least one correlation matrix that is arranged to provide at least part of:
c. storage means arranged to store data of stored images;
d. comparison means arranged to compare the data of the natural image with the stored data of the stored images; and
e. identifying means arranged to identify matches between data of the natural image and said stored data.

15.-16. (canceled)
